(19) United States
(12) Patent Application Publication
(10) Pub. No.: US 2026/0200335 A1
(43) Pub. Date: Jul. 16, 2026

(54) SYSTEMS AND METHODS FOR REDUCING ELECTRIC DRIVE NOISE, VIBRATION AND HARSHNESS

(71) Applicant: Deere & Company, Moline, IL (US)

(72) Inventors: Selin YAMAN, Apex, NC (US); Jason M. EDGINGTON, Cedar Falls, IA (US); Christopher T. REEK, Horace, ND (US); Kent WANNER, Fargo, ND (US)

(73) Assignee: Deere & Company, Moline, IL (US)

(21) Appl. No.: 19/021,623

(22) Filed: Jan. 15, 2025

(51) Int. Cl. B60L 15/10

(52) U.S. Cl. CPC B60L 15/10; B60L 2210/42; B60L 2240/421; B60L 2260/40; B60L 2270/142; B60L 2270/145

(57) ABSTRACT

In an example embodiment, an electric drive system includes an inverter configured to convert a direct current (DC) voltage into an alternating current (AC) voltage for an electric machine; processing circuitry configured to cause the electric drive system to obtain parameters of the electric machine, obtain a mode of operation for the electric machine, the mode of operation related to at least one of noise, vibration and harshness, and control the electric machine based on the parameters of the electric machine and the obtained mode of operation.

### FIELD

Example embodiments are related to systems and methods for reducing electric drive noise, vibration and harshness.

### SUMMARY

At least one example embodiment provides an electric drive system comprising an inverter configured to convert a direct current (DC) voltage into an alternating current (AC) voltage for an electric machine; processing circuitry configured to cause the electric drive system to, obtain parameters of the electric machine, obtain a mode of operation for the electric machine, the mode of operation related to at least one of noise, vibration or harshness, and control the electric machine based on the parameters of the electric machine and the obtained mode of operation.

According to one or more example embodiments, the electric drive system further includes a memory storing a first set of switching frequency values for the inverter, wherein the processing circuitry is configured to generate a second set of switching frequency values for the inverter based on the parameters of the electric machine.

According to one or more example embodiments, the second set of switching frequency values for the inverter corresponds to a resonance reduction mode.

According to one or more example embodiments, the processing circuitry is configured to determine at least one resonance frequency based on the parameters of the electric machine, determine if a particular switching frequency of the first set of switching frequency values is the at least one resonance frequency or is within a first threshold of the at least one resonance frequency, and adjust the particular switching frequency based on whether the particular switching frequency of the first set of switching frequency values is the at least one resonance frequency or is within the first threshold of the at least one resonance frequency.

According to one or more example embodiments, the processing circuitry is configured to adjust the particular switching frequency by applying an adjustment value to the particular switching frequency and determining if the adjusted frequency is not in the first set of switching frequency values.

According to one or more example embodiments, the parameters include at least one of an inner diameter of a stator of the electric machine, an outer diameter of a stator of the electric machine, a stack length of the electric machine, a Poisson's ratio of the electric machine, a mass density of the electric machine, a packing factor of the electric machine or a modulus of elasticity of the electric machine.

According to one or more example embodiments, the processing circuitry is configured to determine the at least one resonance frequency using at least one of Hoppe's equation or Yang's equation.

According to one or more example embodiments, the processing circuitry is further configured to obtain at least one excitation frequency, determine if the particular switching frequency of the first set of switching frequency values is the at least one excitation frequency or is within a second threshold of the at least one excitation frequency, and adjust the particular switching frequency further based on whether the particular switching frequency of the first set of switching frequency values is the at least one excitation frequency or is within the second threshold of the at least one excitation frequency.

According to one or more example embodiments, the processing circuitry configured to cause the electric drive system to select one of the second set of switching frequency values based on a speed of the electric machine, the selected one of the second set of switching frequency values being a switching frequency command for the electric machine.

According to one or more example embodiments, the processing circuitry is configured to cause the electric drive system to obtain the mode of operation from a user of the electric drive system.

According to one or more example embodiments, the electric drive system is a battery electric power drive system or a hybrid electric power drive system.

At least one example embodiment provides a vehicle comprising the electric drive system according to one or more example embodiments.

At least one example embodiment provides a method of controlling an electric drive system comprising obtaining parameters of an electric machine of the electric drive system; obtaining a mode of operation for the electric machine, the mode of operation related to at least one of noise, vibration and harshness; and controlling the electric machine based on the parameters of the electric machine and the obtained mode of operation.

According to one or more example embodiments, the method further includes storing a first set of switching frequency values for an inverter of the electric drive system; and generating a second set of switching frequency values for the inverter based on the parameters of the electric machine.

According to one or more example embodiments, the second set of switching frequency values for the inverter corresponds to a resonance reduction mode.

According to one or more example embodiments, the method further includes determining at least one resonance frequency based on the parameters of the electric machine; determining if a particular switching frequency of the first set of switching frequency values is the at least one resonance frequency or is within a first threshold of the at least one resonance frequency; and adjusting the particular switching frequency based on whether the particular switching frequency of the first set of switching frequency values is the at least one resonance frequency or is within the first threshold of the at least one resonance frequency.

According to one or more example embodiments, the adjusting adjusts the particular switching frequency by applying an adjustment value to the particular switching frequency and determining if the adjusted frequency is not in the first set of switching frequency values.

According to one or more example embodiments, the parameters include at least one of an inner diameter of a stator of the electric machine, an outer diameter of a stator of the electric machine, a stack length of the electric machine, a Poisson's ratio of the electric machine, a mass density of the electric machine, a packing factor of the electric machine or a modulus of elasticity of the electric machine.

According to one or more example embodiments, the method further includes obtaining at least one excitation frequency; determining if the particular switching frequency of the first set of switching frequency values is the at least one excitation frequency or is within a second threshold of the at least one excitation frequency; and adjusting the particular switching frequency further based on whether the particular switching frequency of the first set of switching frequency values is the at least one excitation frequency or is within the second threshold of the at least one excitation frequency.

According to one or more example embodiments, the method further includes selecting one of the second set of switching frequency values based on a speed of the electric machine, the selected one of the second set of switching frequency values being a switching frequency command for the electric machine.

### BRIEF DESCRIPTION OF THE DRAWINGS

Example embodiments will be more clearly understood from the following detailed description taken in conjunction with the accompanying drawings. FIGS. 1-7 represent non-limiting, example embodiments as described herein.

FIG. 1 is a block diagram of an electric drive system, according to one or more example embodiments;

FIG. 2 is a block diagram of an electronic data processing system consistent with FIG. 1, according to an example embodiment;

FIG. 3 illustrates a flow chart of selecting mode to reduce noise, vibration and harshness (NVH) according to one or more example embodiments;

FIG. 4 illustrates a silence mode of operation according to one or more example embodiments;

FIG. 5 illustrates a method of reducing harmonics and updating a switch scheduling according to one or more example embodiments;

FIG. 6 illustrates a method of updating a switch scheduling using diagnostics according to one or more example embodiments; and

FIG. 7 illustrates a method of operation according to one or more example embodiments.

### DETAILED DESCRIPTION

Some example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a controller area network (CAN) local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one embodiment of the invention relates to a non-transitory computer-readable storage medium comprising electronically readable control information stored thereon, configured in such that when the storage medium is used in a controller of a magnetic resonance device, at least one embodiment of the method is carried out.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects.

The term memory is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways. The term data storage device may be used interchangeably with computer-readable medium.

When it comes to battery electric vehicles (BEVs) and hybrid electric vehicles (HEVs), tones are often generated from excitation frequencies and higher frequency content. Example embodiments manage and/or reduce these tones, resulting in improved customer satisfaction.

Inverters are actively in use in many electrification projects along with different e-Machines. For noise, vibration and harshness (NVH) perspective, existing solutions have been provided in ad-hock and project-based nature instead of an analytical approach that is application agnostic. At least some example embodiments provide an inverter system smart solution that allow a user to select a silent mode.

Electric drive noise sources can be classified as electromagnetic, mechanical, aerodynamic and electronic. In an electric drive (e-Drive) NVH analysis, switching frequencies play a role as the frequency that excitation current flows generate the radial forces which are a main trigger for electromagnetic based motor noise. To avoid additional costs associated with a sensor based implementations, at least some example embodiments provide a solution that systematically mitigates NVH issues without additional sensors.

In addition, the inverter system provides methods of reducing and/or removing resonance in a “plug and play” fashion without additional hardware costs.

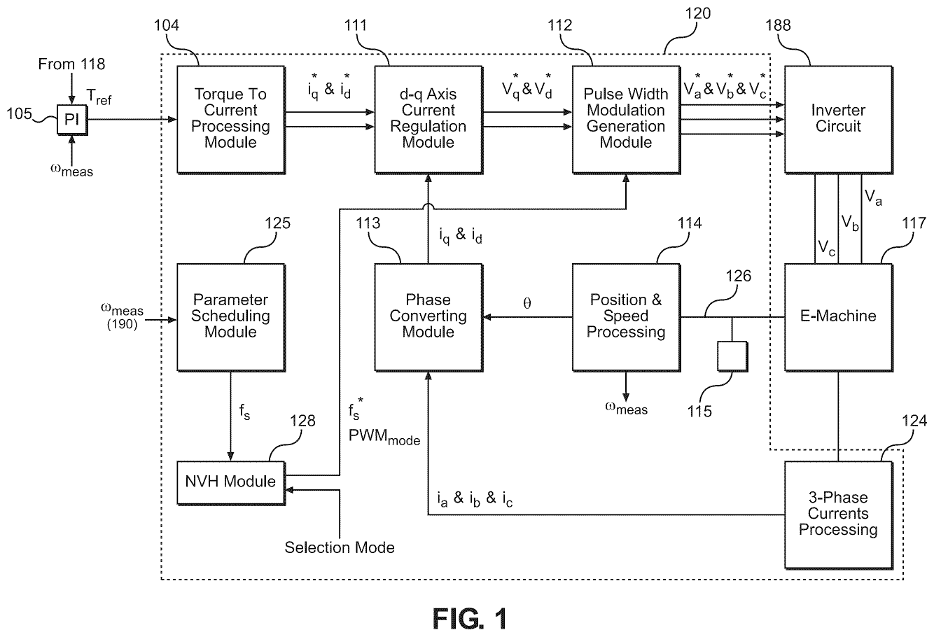

FIG. 1 is a block diagram of an electric drive system (e.g., a battery electric power drive system or a hybrid electric power drive system), according to one or more example embodiments.

FIG. 1 is a block diagram of a system for controlling an electrical motor, according to an example embodiment. The electrical machine may be a motor such as a motor 117 (e.g., an interior permanent magnet (IPM) motor) or another alternating current machine controlled by an electronic data processing system 120. Hereinafter, the terms, hybrid machine, electrical motor, AC machine and a motor may be used interchangeably. The motor 117 has a nominal dc bus voltage. The nominal voltage is a named voltage. In some example embodiments, a nominal voltage may be 32 VDC to 1000 VDC.

In an example embodiment, the electronic data processing system 120 may be referred to as an electric machine controller. The electronic data processing system 120 in combination with an inverter circuit 188 may be referred to as an inverter system.

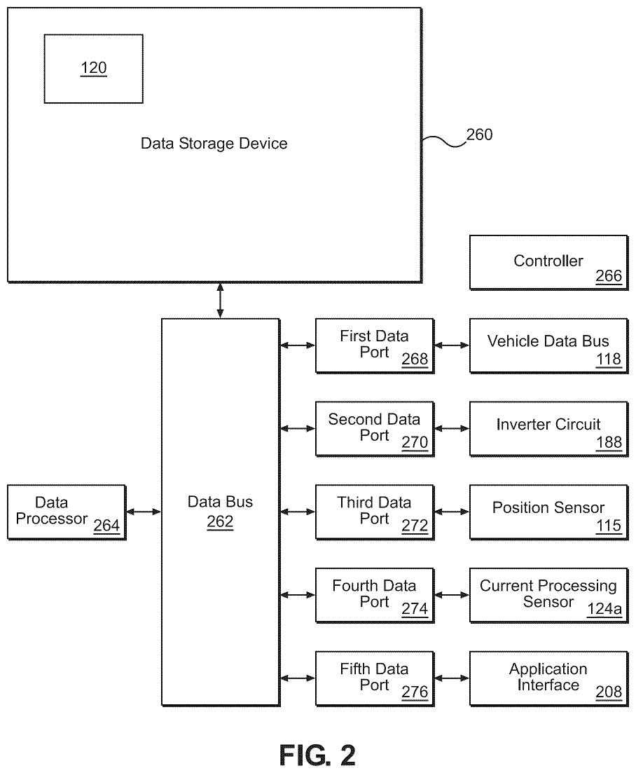

The electronic data processing system 120 includes electronic modules, software modules, or both. In an example embodiment, the electronic data processing system 120 includes at least one processor and a memory to support storing, processing and execution of software instructions of one or more software modules. The electronic data processing system 120 is indicated by the dashed lines in FIG. 1 and is shown in greater detail in FIG. 2.

In an example embodiment, the data processing system 120 receives an input control data message, such as a speed control data message, a voltage control data message, or a torque control data message over a vehicle data bus 118 (shown in FIG. 2). A PI controller 105 converts the received input control message into a reference torque T_{ref} based on a measured speed ωₘₑₐₛ. For example, the PI controller 105 may determine a difference between a requested speed in the speed control data message and the measured speed ωₘₑₐₛ and generate the reference torque T_{ref} based on the difference. The reference torque T_{ref} may also be referred to as a torque command. A torque to current processing module 104 generates one or more outputs (e.g., direct axis current command (i_{d}*) and quadrature axis current command (i_{q}*)) based on the reference torque T_{ref}. More specifically, the torque to current processing module 104 may include d-q axis current generation look-up tables that indicates d-q current commands for a particular reference torque. Alternatively or additionally, the torque to current processing module 104 may use analytical equations, regression models, neural networks or fuzzy logic control models.

The d-q axis current refers to the direct axis current and the quadrature axis current as applicable in the context of vector-controlled alternating current machines, such as the motor 117. The one or more outputs of the current processing module 104 are provided or coupled to a current regulation controller 111. While the term current command is used, it should be understood that current command refers to a target current value.

The current regulation controller 111 is capable of communicating with a pulse-width modulation (PWM) generation module 112 (e.g., space vector PWM generation module). The current regulation controller 111 receives respective d-q axis current commands (e.g., i_{d}* and i_{q}*), and actual d-q axis currents (e.g., i_{d} and i_{q}) and outputs corresponding d-q axis voltage commands (e.g., v_{d}* and v_{q}* commands) for input to the PWM generation module 112.

In an example embodiment, the PWM generation module 112 converts the d-q axis voltage commands from two phase data representations into three phase representations (e.g., three phase voltage representations, such as vₐ*, v_{b}* and v_{c}*) for control of the motor 117 using a switching frequency fₛ ^{*}. The three phase voltage representations vₐ*, v_{b}* and v_{c}* may be referred to as inverter terminal voltages. Outputs of the PWM generation module 112 are coupled to an inverter circuit 188 (an inverter). The output stage of the inverter circuit 188 (e.g., output terminal voltages vₐ, v_{b} and v_{c}) provides a pulse-width modulated voltage waveform or other voltage signal for control of the motor 117. In an example embodiment, the inverter circuit 188 is powered by a direct current (DC) voltage bus. As will be further described below, there may be more than one inverter in the inverter circuit 188. For example, there may be a generator side inverter associated with a generator machine and a separate inverter (load inverter) associated with the load machine (motor 117). In one example embodiment, if there is more than one load machine, then there may be a corresponding number of load inverters in the inverter circuit 188.

Alternatively, there may be two or more inverter circuits 188, where each inverter circuit is either associated with either the generator machine or one or more load machines.

In one example embodiment, the inverter circuit 188 is a semiconductor drive circuit that drives or controls switching semiconductors (e.g., insulated gate bipolar transistors (IGBT) or other power transistors, including but not limited to, a metal-oxide Semiconductor Field-Effect Transistor (MOSFET), a Silicon Carbide MOSFET or a Silicon Carbide IGBT) to output control signals for the motor 117. In turn, the inverter circuit 188 is coupled to the motor 117.

Each transistor is coupled electrically to a respective gate driver that is dedicated to that transistor and may provide a low DC voltage (e.g., 24 VDC) to turn on and off that transistor. The gate drivers are under the control of the processing circuitry, which may employ a pulse-width-modulation control scheme to control those gate drivers to supply electric energy on a direct current (DC) bus in a generating mode. In example embodiments, space vector modulation may be used. In other example embodiments, the gate drivers are under the control of the processing circuitry, which may employ a pulse-width-modulation control scheme to remove electric energy from the DC bus in a motoring mode.

The motor 117 is associated with a sensor 115 (e.g., a position sensor, a resolver or encoder position sensor) that is associated with a motor shaft 126 or the rotor. The sensor 115 and the motor 117 are coupled to the electronic data processing system 120 to provide feedback data (e.g., current feedback data, such as phase current values iₐ, i_{b} and i_{c}), raw position signals, among other possible feedback data or signals, for example. Other possible feedback data includes, but is not limited to, winding temperature readings, semiconductor temperature readings of the inverter circuit 188, three phase voltage data, or other thermal or performance information for the motor 117.

The motor 117 is associated with the sensor 115 (e.g., a resolver, encoder, speed sensor, or another position sensor or speed sensors) that estimates at least one of an angular position of the motor shaft 126, a speed or velocity of the motor shaft 126, and a direction of rotation of the motor shaft 126. The sensor 115 may be mounted on or integral with the motor shaft 126. The output of the sensor 115 is capable of communication with the position and speed processing module 114. In an example embodiment, the sensor 115 may be coupled to an analog-to-digital converter (not shown) that converts analog raw position data or velocity data to digital raw position or velocity data, respectively. In other example embodiments, the sensor 115 (e.g., digital position encoder) may provide a digital data output of raw position data or velocity data for the motor shaft 126 or rotor.

A first output (e.g., position data θ for the motor 117) of the position and speed processing module 114 is communicated to a phase converting module 113 (e.g., three-phase to two-phase current Park transformation module) that converts respective three-phase digital representations of measured current into corresponding two-phase digital representations of measured current. A second output (e.g., measured speed data ωₘₑₐₛ for the motor 117) of the primary processing module 114 is communicated to a parameter scheduling module 125.

An input of a 3-phase current processing module 124 is coupled to terminals of the motor 117 for sensing at least the measured three-phase currents and a voltage level of the direct current (dc) bus (e.g., high voltage dc bus which may provide dc power to the inverter circuit 188). The 3-phase current processing module 124 may include a dedicated current sensor or may be a sensorless processing module. The 3-phase current processing digitizes the three phase currents iₐ, i_{b} and i_{c}. The 3-phase current processing module 124 is associated with the motor 117 for measuring three phase currents (e.g., current applied to the windings of the motor 117, back EMF (electromotive force) induced into the windings, or both).

Certain outputs of the 3-phase current processing module 124 feed the phase converting module 113. For example, the phase converter module 113 may apply a Park transformation or other conversion equations (e.g., certain conversion equations that are suitable are known to those of ordinary skill in the art) to convert the measured three-phase representations of current into two-phase representations of current based on the digital three-phase current data iₐ, i_{b} and i_{c} from the 3-phase current processing module 124 and position data θ from the position and speed processing module 114. The output of the phase converter module 113 (i_{d}, i_{q}) is coupled to the current regulation controller 111.

The torque to current processing module 104 selects or determines the direct axis current command and the quadrature axis current command associated with the respective reference torque T_{ref} (i.e., a respective torque command). In some example embodiments, the reference torque T_{ref} is input by a user through an interface (e.g., in a torque mode). In other example embodiments, the reference torque T_{ref} is generated from the PI controller 105 using a difference between a speed command and a measured speed ωₘₑₐₛ. For example, the torque to current processing module 104 selects or determines the direct axis current command and the quadrature axis current command by accessing one or more of the following: (1) a look-up table, database or other data structure that relates respective torque commands to corresponding direct and quadrature axes currents, (2) a set of quadratic equations or linear equations that relate respective torque commands to corresponding direct and quadrature axes currents, or (3) a set of rules (e.g., if-then rules) that relates respective torque commands to corresponding direct and quadrature axes currents such as rules relating to rotor magnet temperature, torque load on the motor 117, speed of the motor 117 and terminal voltage. Alternatively or additionally, the torque to current processing module 104 may use analytical equations, regression models, neural networks or fuzzy logic control models.

In an example embodiment, the motor 117 may include an interior permanent magnet (IPM) machine or a synchronous IPM machine (IPMSM).

The sensor 115 (e.g., shaft or rotor speed detector) may include one or more of the following: a direct current motor, an optical encoder, a magnetic field sensor (e.g., Hall Effect sensor), magneto-resistive sensor, and a resolver (e.g., a brushless resolver). In one configuration, the sensor 115 includes a position sensor, where raw position data and associated time data are processed to determine speed or velocity data for the motor shaft 126. In another configuration, the sensor 115 includes a speed sensor, or the combination of a speed sensor and an integrator to determine the position of the motor shaft.

In yet another example embodiment, the sensor 115 includes an auxiliary, compact direct current generator that is coupled mechanically to the motor shaft 126 of the motor 117 to determine speed of the motor shaft 126, where the direct current generator produces an output voltage proportional to the rotational speed of the motor shaft 126. In still another configuration, the sensor 115 includes an optical encoder with an optical source that transmits a signal toward a rotating object coupled to the motor shaft 126 and receives a reflected or diffracted signal at an optical detector, where the frequency of received signal pulses (e.g., square waves) may be proportional to a speed of the motor shaft 126. In an additional configuration, the sensor 115 includes a resolver with a first winding and a second winding, where the first winding is fed with an alternating current, where the voltage induced in the second winding varies with the frequency of rotation of the rotor.

The electronic data processing system 120 further includes the parameter scheduling module 125 and a noise, vibration and harshness (NVH) module 128. The parameter schedule module 125 generates a switching frequency fₛ based on the measured speed ωₘₑₐₛ. In an example embodiment, the parameter schedule module 125 may include a table that stores sampling frequencies for respective measured speeds.

The NVH module 128 receives an input indicating whether a particular NVH mode (e.g., performance mode, silence mode or balanced mode) or no mode has been selected. Based on the selected mode, the NVH module 128 determines whether the switching frequency is associated with NVH (e.g., is a harmonic frequency) and generates a switching frequency command fₛ* for the PWM module 112 that reduces NVH according to the selected mode. The NVH module 128 also indicates a PWM method (PWM_{mode}) to the PWM module 112 for the PWM module 112 to use.

In some example embodiments, the NVH module 128 reduces and/or remove resonance in a “plug and play” or sensorless fashion without additional hardware costs.

FIG. 2 is a block diagram of an electronic data processing system consistent with FIG. 1, according to an example embodiment. In FIG. 2, the electronic data processing system 120 includes an electronic data processor 264, a data bus 262, a data storage device 260, and one or more data ports (268, 270, 272, 274 and 276). The data processor 264, the data storage device 260 and one or more data ports are coupled to the data bus 262 to support communications of data between or among the data processor 264, the data storage device 260 and one or more data ports.

In an example embodiment, the data processor 264 may include an electronic data processor, a microprocessor, a microcontroller, a programmable logic array, a logic circuit, an arithmetic logic unit, an application specific integrated circuit, a digital signal processor, a proportional-integral-derivative (PID) controller, or another data processing device.

The data storage device 260 may include any magnetic, electronic, or optical device for storing data. For example, the data storage device 260 may include an electronic data storage device, an electronic memory, non-volatile electronic random access memory, one or more electronic data registers, data latches, a magnetic disc drive, a hard disc drive, an optical disc drive, or the like.

As shown in FIG. 2, the data ports include a first data port 268, a second data port 270, a third data port 272, a fourth data port 274 and a fifth data port 276. While in FIG. 2, 5 data ports are shown, any suitable number of data ports may be used. Each data port may include a transceiver and buffer memory, for example. In an example embodiment, each data port may include any serial or parallel input/output port.

In an example embodiment as illustrated in FIG. 2, the first data port 268 is coupled to a vehicle data bus 118. In turn, the vehicle data bus 118 is coupled to a controller 266. In one configuration, the second data port 270 may be coupled to the inverter circuit 188; the third data port 272 may be coupled to the sensor 115; the fourth data port 274 may be coupled to a current processing sensor 124a; and the fifth data port 276 may be coupled to an application interface 208.

In an example embodiment of the data processing system 120, the torque reference T_{ref} is received through the application interface 208 supported by the fifth data port 276. In other example embodiments, the torque reference T_{ref} is generated from the speed control 103. The first data port 268 may be coupled to a vehicle data bus 118, such as a controller area network (CAN) data bus. The vehicle data bus 118 may provide data bus messages with torque commands to the PI controller 105 via the first data port 268. In other example embodiments, the operator of a vehicle may generate the torque commands via a user interface, such as a throttle, a pedal, the controller 266, or other control devices. In some example embodiments, the application interface 208 is implemented by the controller 266.

In one example embodiment, the PWM generation module 112 may communicate with the inverter circuit 188 and/or the data processor 264 via the second data port 270. In some example embodiments, the sensor 115 may communicate with the position and speed processing module 114 and/or the data processor 264 via the third data port 272.

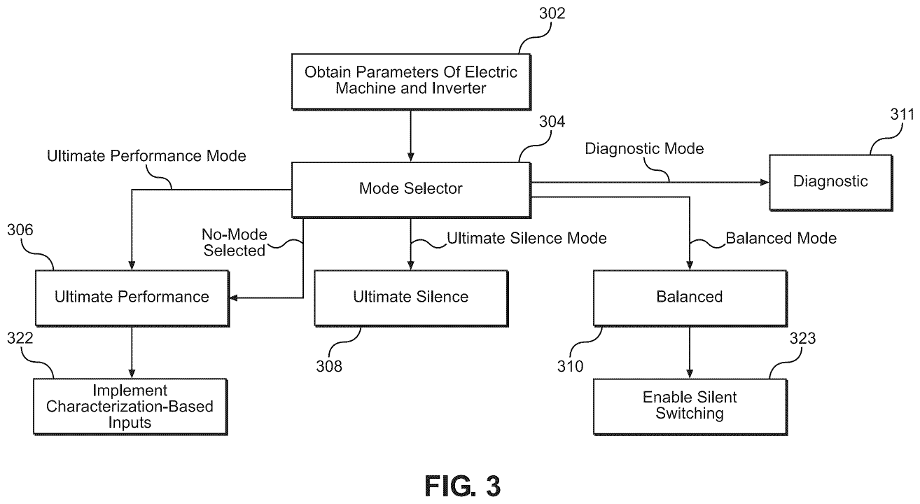

FIG. 3 illustrates a flow chart of selecting mode to reduce noise, vibration and harshness (NVH) according to one or more example embodiments.

The flow chart may be implemented in an electric drive system such as the electric drive system described in FIGS. 1-2 (e.g., the data processor 264 executing the NVH module 128).

At 302, the electric drive system obtains parameters of the inverter and electric machine. The electric machine may be a three-phase motor such as an interior permanent magnet synchronous motor (IPMSM). However, example embodiments are not limited thereto. The parameters of the electric machine may be input by a user into the drive system using an application interface (e.g., the application interface 208) or the parameters of the electric machine may automatically be transferred into the electric drive system (e.g., into the data storage 260) upon connecting the electric machine to the inverter. For example, the parameters of the electric machine may be indicated in configurable xml files (e.g., end of line (EOL) files).

In some example embodiments, the parameters of the electric machine include an inner diameter and an outer diameter of a stator yoke, a stack length, a Poisson's ratio, a mass density, a modulus of elasticity and a packing factor. However, example embodiments are not limited thereto. For example, other parameters may include lumped stiffness and the lumped mass of the stator, stator core thickness, stator mass, and the stator mean diameter, mass density of the stator core, the stacking factor, and a mass addition factor for displacement (depending on the mass of all stator teeth, mass of stator windings, mass of insulation, mass of the stator core).

At 304, the user uses a mode selector (e.g., through the application interface 208) to select a mode associated with NVH. For example, the user may select one of a performance mode, silence mode, balanced mode, diagnostic mode or no mode at all.

The NVH module receives the selection from the user. If the user selects the performance mode, the NVH module implements the performance mode at 306. In the performance mode, characterization-based inputs are implemented at 322. Characterization-based inputs may include DC Bus voltage, motor speed and MTPA (maximum torque per ampere) lookup tables. In the performance mode, existing parameters that are already tuned for performance are used, which describes maximum achievable torque for a given i_{d} & i_{q} current pair, within the current limits. Performance modes reaches a maximum torque out of the e-Machine by providing dq currents that are within the current limits of the system. In the performance mode, a default switch scheduling is used. In other words, the NVH module applies a default switch scheduling according to motor characterization such that the switching frequency fₛ from the parameter scheduling module 125 is used for the PWM generation module. The default switching scheduling may be referred to as a first set of switching frequency values and the switching frequency fs may be referred to as the default switching frequency.

During motor characterization, multiple current commands are used at different speed points, which generates MTPA (maximum torque per amp) and MTPV (maximum torque per volt) curves. Many items are recorded such as phase current, phase voltage, torque, speed, etc. Efficiency data is generated by recording machine input power (terminal power) and also shaft power. By dividing shaft power by input power for each characterized operational point, an efficiency lookup table is generated. Then the inputs to the lookup table are the torque command percentage and voltage/speed ratio. The output will be an efficiency value. Generally, motor characterization is a procedure used to determine d-axis and q-axis commands for a specific speed and torque command. The procedure is repeated at multiple torque commands and multiple speeds. Any known motor characterization procedure may be used.

During characterization, the pulse-width modulation generation module 112 or the data processor 264 varies a switching frequency of a pulse-width-modulation (PWM) signal in accordance with the selected speed range. The default switch scheduling may be a look up table storing switching frequencies for corresponding speed ranges based on the characterization considering effects like torque ripple, efficiency, control responsiveness, heat generation etc.

In some example embodiments, the default switching frequencies may be based on a change from a previous speed range to a selected speed range. In other example embodiments, the default switching frequencies may be based on a phase current imbalance between the three phases and/or a ratio of one phase current to another phase current.

If the user selects the silence mode at 304, the NVH module implements the silence mode at 308. If the user selects the balanced mode at 304, the NVH module implements the balanced mode at 310. More specifically, at 323, the NVH enables silent switching (silent modulation). The NVH module enables a silent modulation by sending a command to the PWM module 112 to use the silent modulation. The silent modulation technique could be the quietest PWM technique (e.g., least percentage of total harmonic distortion). In one example embodiment, the silent modulation technique is SVPWM.

If the user selects the diagnostic mode at 304, the NVH module implements the diagnostic mode at 311. If the user does not select a mode associated with NVH, the NVH module implements the performance mode at 306.

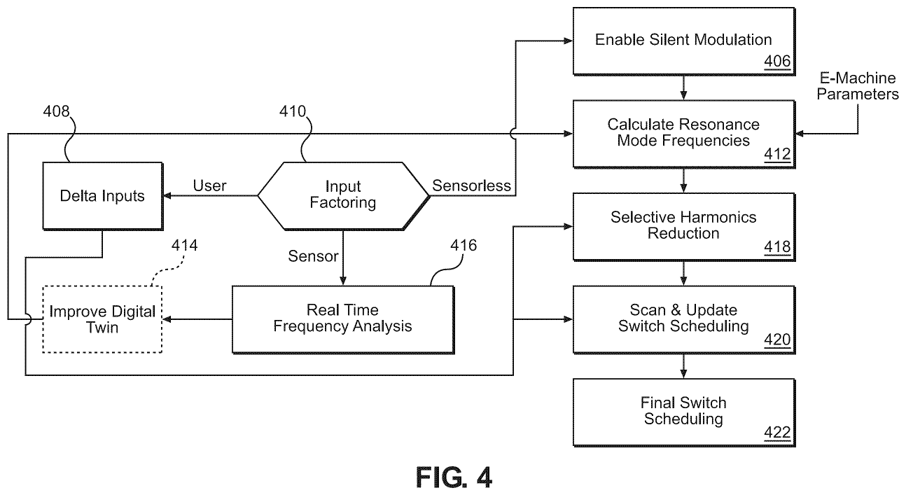

FIG. 4 illustrates a silence mode of operation according to one or more example embodiments. In the silence mode dominant vibrations and excitation frequencies (frequencies due to number of poles and rotational speeds) are avoided by incorporation selective harmonic selection and enabling a quiet modulation mode. The flow chart of FIG. 4 is implemented by the NVH module (e.g., the data processor 264 executing the NVH module 128).

If the silence mode is on, at 410, the NVH module determines an input that controls a change in the default switch scheduling. Switching frequencies play a role in NVH as the frequency that excitation current flows generate the radial forces which are a main trigger for electromagnetic based motor noise. The default switching frequencies may include at least one frequency that causes an undesirable resonance within the electric drive system (i.e., a resonant frequency).

In the silence mode, the NVH module may apply a delta (e.g., an increase or decrease) to a default switching frequency fₛ such that the change results in a switching frequency fₛ* that is not a resonant frequency.

At 410, if a user will input the delta, the NVH module permits the user to add the delta to the default switching frequencies. To avoid exceeding the switching capability of the inverter circuit 188, a maximum delta may be set such that the user may not select a delta that exceeds the maximum delta. The NVH module then performs selective harmonics reduction at 418 and updates the switch scheduling (e.g., changing fₛ to fₛ*) at 420. 418 and 420 are described in greater detail below.

In some example embodiments, the user may adjust the delta values based on NVH performance.

If a part of the electronic drive system includes at least one sensor (e.g., accelerometer, microphone or strain gage) to measure the resonance frequencies of the motor, the NVH module performs a real time frequency analysis at 416. The real time frequency analysis may include performing a Real time Fast Fourier Transform (FFT) on the data collected by the sensor. The collected data includes acceleration if the sensor is an accelerometer; audible noise if the sensor is a microphone; and electrical resistance or voltage (depending on if Wheatstone bridge circuit is used or not).

At 414, the electric drive system may store a digital twin of the electric for diagnostics. The electric drive system may use the real time frequency analysis to improve the digital twin. The digital twin is not only useful for diagnostics but also estimating future health problems.

The real time frequency analysis is used to calculate resonance mode frequencies at 412. The resonance frequencies are calculated by converting a time domain signal from the sensor (e.g., accelerometer) is converted into the frequency domain and frequencies with most dramatic responses are identified as resonance frequencies. In some example embodiments, the resonance frequencies coinciding with excitation frequency multiples are defined as excitation frequencies.

Returning to 410, the NVH module enables a silent modulation only at 406 if the resonance frequencies are determined using a sensorless implementation. In other words, the NVH module sends a command to the PWM module 112 to use the silent modulation. The silent modulation technique could be the quietest PWM technique. In one example embodiment, the silent modulation technique is SVPWM.

In the sensorless implementation, the e-machine parameters are provided to calculate and avoid/reduce domination vibration frequencies and excitation frequencies.

At 412, as part of the sensorless implementation, the NVH module may use the parameters of the electric machine (e.g., an inner diameter and an outer diameter of a stator yoke, a stack length, a Poisson's ratio, a mass density, a modulus of elasticity and a packing factor) and Hoppe's equation (e.g., for vibration mode) and/or Yang's equation (e.g., for breathing mode) as part of calculating the resonance mode frequencies. Additionally or alternatively, the NVH module may use Rayleigh's Method, Timoshenko Beam Theory, Curry and Ralston's Formula, Coulomb Damping Model, Meyer's method, Hertzian method, a sub-combination thereof, or a combination thereof.

As shown in FIG. 4, the resonance mode frequencies are determined based on the parameters of the electric machine.

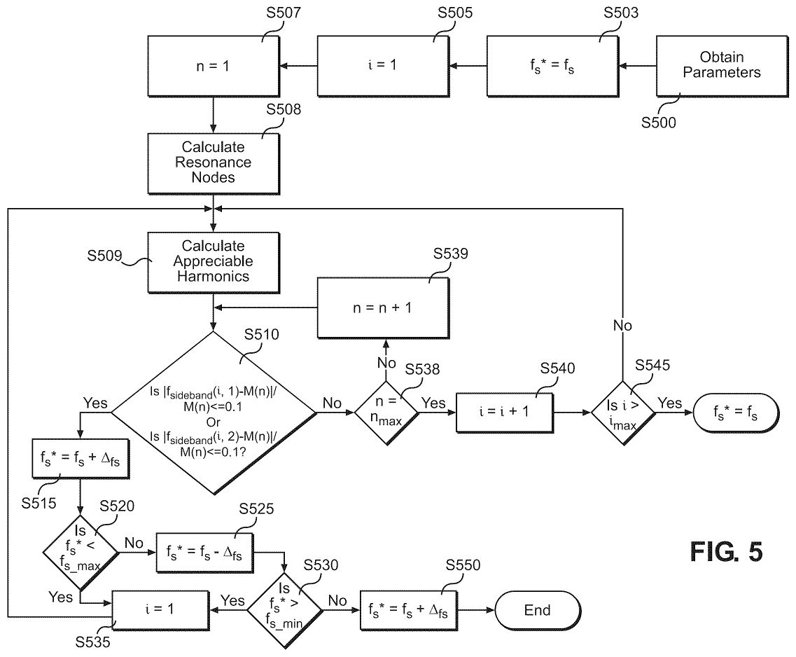

At 418, the NVH module uses the resonance mode frequencies to reduce selective harmonics, which is described in greater detail below with reference to FIG. 5.

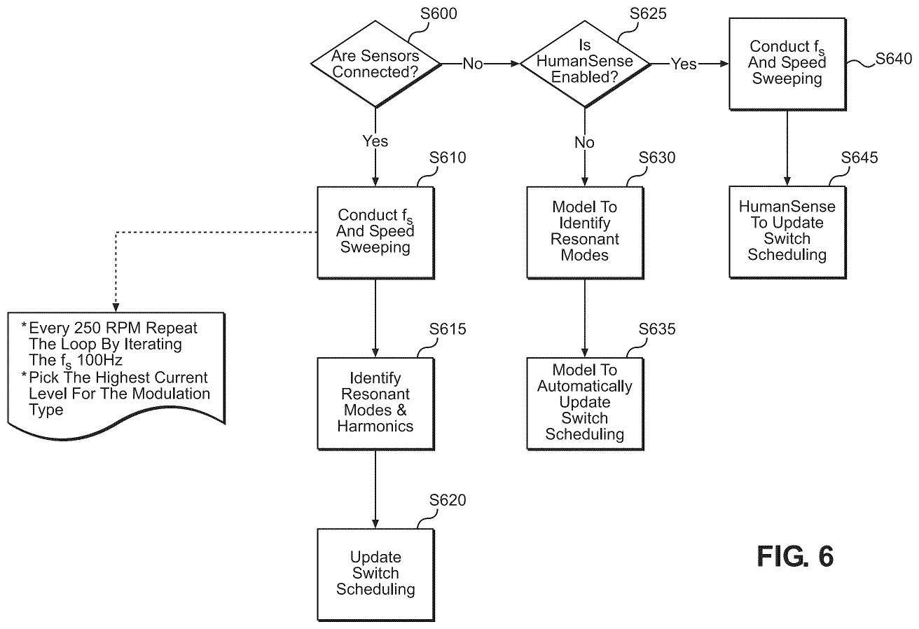

At 420, the NVH module uses the reduced harmonics to scan and update the default switch scheduling, which is described in greater detail below with reference to FIG. 6.

At 422, the NVH module uses the updated switch scheduling (e.g., changing fₛ to fₛ* when fₛ is a harmonic or resonant frequency) to provide the switching frequency fₛ* and modulation technique to the PWM module 112. Thus, the PWM module 112 uses switch scheduling that includes switching frequencies that are no resonance frequencies. The updated switch scheduling may be referred to as a second set of switching frequency values.

FIG. 5 illustrates a method of reducing harmonics and updating a switch scheduling according to one or more example embodiments.

At S500, the NVH module obtains the number of pole pairs pp and rotor operating speed of the motor (i.e., ωₘₑₐₛ), a default switching table that stores the default switching frequencies fₛ for measured speeds, respectively, modulation type, a minimum switching frequency f_{s_min} and a maximum switching frequency f_{s_max}.

For the maximum switching frequency f_{s_max}, there are hard limits based on the hardware (due to various factors such as thermal and electrical stress on dc-link capacitors). A user can select a suggested maximum switching frequency provided in the inverter, or select any values less than the maximum switching frequency f_{s_max}. The minimum switching frequency f_{s_min}, depends on the connected e-machine, since the minimum switching frequency f_{s_min} affects current and torque control and quality. If a desired minimum frequency is known, the NVH module uses the known minimum frequency as the minimum switching frequency f_{s_min}. If the minimum frequency is unknown, the NVH module initially uses an industry standard low frequency for high-power systems such as 1 kHz as the minimum switching frequency f_{s_min}.

At S503, the NVH module sets the switching frequency command fs* to be the default switching frequency fₛ associated with the measured operating speed ωₘₑₐₛ.

At S505, the NVH module initiates the harmonic number i to one (i.e., the first harmonic). At S507, the NVH module initiates the resonance mode frequency number n to one.

At S508, the NVH module calculates a number of resonance mode frequencies nₘₐₓ using any of the methods described above with respect to determining resonance frequencies. At S509, a number of appreciable harmonic frequencies (including pole pair harmonics, sideband frequencies and excitation frequencies) iₘₐₓ. for resonance modes n (number of total resonance modes being nₘₐₓ). The sideband frequencies are based on the switching frequency fₛ.

In some example embodiments, the harmonic frequencies considered by the NVH module are limited to what the NVH module deems appreciable. In some example embodiments, the number of appreciable frequencies is a fixed value such as five.

Using the pole pair data and the operating speed of the rotor, the NVH module calculates harmonic frequencies of the motor. More specifically, the NVH module calculates excitation frequencies fₑ(i) (where fₑ(i)=i×((2*pp*ωₘₑₐₛ)/60)) for iₘₐₓ frequencies and pp pole pairs. If a switching frequency fₛ for the obtained speed at S500 and/or a resonance frequency coincides with excitation frequencies fₑ(i), there will be an amplified NVH response at that particular switching frequency.

For example, if the motor is running at 6000 RPM and it has 2 pole pairs then 4 (poles)×6000/60=400 Hz, so there will be harmonic frequencies at 400 Hz, 800 Hz, 1200 Hz, 1600 Hz. And if the Mode 2 resonance frequency is happening at 1200 Hz, there will be a considerable NVH response.

At S510, the NVH module determines whether a sideband frequency for the order i f_{sideband}(i) is within a threshold band of resonance mode frequency M(n). In some example embodiments, the threshold band may be 10%. The sideband frequency f_{sideband}(i) is f_{sideband}(i)=|fₛ*+/−fₑ(i)|. Thus, at S510, the NVH module determines whether a difference between M(n) and |fₛ*−fₑ(i)| (i.e., f_{sideband}(i,1)]) is greater than or equal to 0.1 of M(n). If the difference is less than 0.1 of M(n), the method proceeds to S515. At S510, the NVH module also determines whether a difference between M(n) and |fs*+fe(i)| (i.e., f_{sideband}(i,2)]) is greater than or equal to 0.1 of M(n). If the difference is less than 0.1 of M(n), the method also proceeds to S515. When both differences are greater than or equal to 0.1 of M(n), the method proceeds to S538.

If the NVH module determines that the sideband frequency f_{sideband}(i) is within the threshold band (i.e., less than than the threshold band) of the resonance mode frequency M(n), the NVH module updates the switching frequency command fₛ* to be fₛ+Δ_{fs} at S515 where Δ_{fs} is a frequency shift (adjustment value). In some example embodiments, the frequency shift Δ_{fs} may be a half of a first excitation frequency (e.g., if the excitation frequency is 400 Hz, the frequency shift Δ_{fs} is 200 Hz). In other example embodiments, the frequency shift Δ_{fs} is 100 Hz. Additionally or alternatively, the frequency shift Δ_{fs} is a predetermined amount.

At S520, the NVH module determines whether the switching frequency command fₛ* is greater than the maximum switching frequency f_{s_max}. If the switching frequency command fₛ* is greater than the maximum switching frequency f_{s_max}, the NVH module updates the switching frequency command fₛ* to be fₛ−Δ_{fs} at S525. In other words, instead of increasing the default switching frequency fₛ by the frequency shift Δ_{fs}, the NVH module decreases the default switching frequency fₛ by the frequency shift Δ_{fs} to generate the switching frequency command fₛ*.

At S530, the NVH module determines whether the switching frequency command fₛ* is less than the minimum switching frequency f_{s_min}. If the switching frequency command fₛ* is less than the minimum switching frequency f_{s_min}, the NVH module determines a no solution situation and uses the default switching frequency fₛ+Δ_{fs} for the switching frequency command fₛ* at S550.

If the switching frequency command fₛ* is not less than the minimum switching frequency f_{s_min,} the NVH module resets i to one at S535. Similarly, if the switching frequency command fₛ* is not greater than the maximum switching frequency f_{s_max}, the NVH module resets i to one at S535 and the method returns to S509 where the appreciable harmonics are recalculated using the updated switching frequency command fₛ*.

If the NVH module determines that the sideband frequency f_{sideband}(i) is outside the threshold band (i.e., greater than or equal to the threshold band) of the resonance mode frequency M(n), the NVH module determines whether the resonance mode number is at a maximum number nₘₐₓ at S538. If n is not nₘₐₓ, then the NVH module increases n by one at S539 and the method returns to S510.

If n is nₘₐₓ, the method proceeds to S540.

At S540, the NVH module sets the order i to i+1 at S540. At S545, the NVH module determines whether the order i greater than the maximum number of harmonic frequencies iₘₐₓ. If the order i is not greater than the maximum number of harmonic frequencies iₘₐₓ, the method returns to S509. If the order i is greater than the maximum number of harmonic frequencies iₘₐₓ, the method ends.

FIG. 6 illustrates a diagnostics mode according to one or more example embodiments. At S600, the NVH module determines with the sensors of the electric drive system are connected. If the sensors are connected the NVH module runs a switching frequency and speed sweep for each switching frequency at S610. More specifically, for every 250 RPM, the NVH module repeats the switching frequency sweep by iterating the switching frequency fₛ 100 Hz. The range of speeds is based on the selected or attached e-Machine, such that information can be obtained either by pre-testing, or from a motor tag or from a supplier. In some example embodiments, switching frequencies can start from 500 Hz to a maximum range of the inverter which can go up to 20 kHz. In addition, there are current or temperature thresholds (depends on the inverter) to switch between silent modulation (e.g., SVPWM) and a high-torque modulation (e.g., discontinuous PWM (DPWM)). For sensors to read and record, in some example embodiments, performing the sweep is performed at a highest possible current for the modulation type. However, example embodiments are not limited thereto.

At S615, the NVH module determines the resonance modes using the results of the switching frequency and speed sweep. The NVH module may determine the resonance modes using any of one of the equations described above (e.g., Hoppe's equation, Yang's equation, Rayleigh's Method, Timoshenko Beam Theory, Curry and Ralston's Formula, Coulomb Damping Model, Meyer's method, Hertzian method, a sub-combination thereof, or a combination thereof). In addition, the NVH module identifies which switching frequencies coincide with resonant frequencies.

Once the NVH module determines the resonance modes using the results of the switching frequency and speed sweep, the NVH module may update the switching scheduling at 720 using the method described in FIG. 5.

If the sensors are not connected, the NVH module determines whether technician interaction (HumanSense) is enabled at S625. If HumanSense is not enabled at S625, the NVH module uses a model to identify resonant modes at S630. The model may be the same analytical model described above using motor parameters to calculate resonance modes. At S635, the NVH module may then update the switching scheduling using the identified resonant modes from S630. S635 may be done in the same manner as S620.

If HumanSense is enabled at S625, the technician conducts the switching frequency and speed sweep for each switching frequency at S640. The technician then updates the switch scheduling at S645.

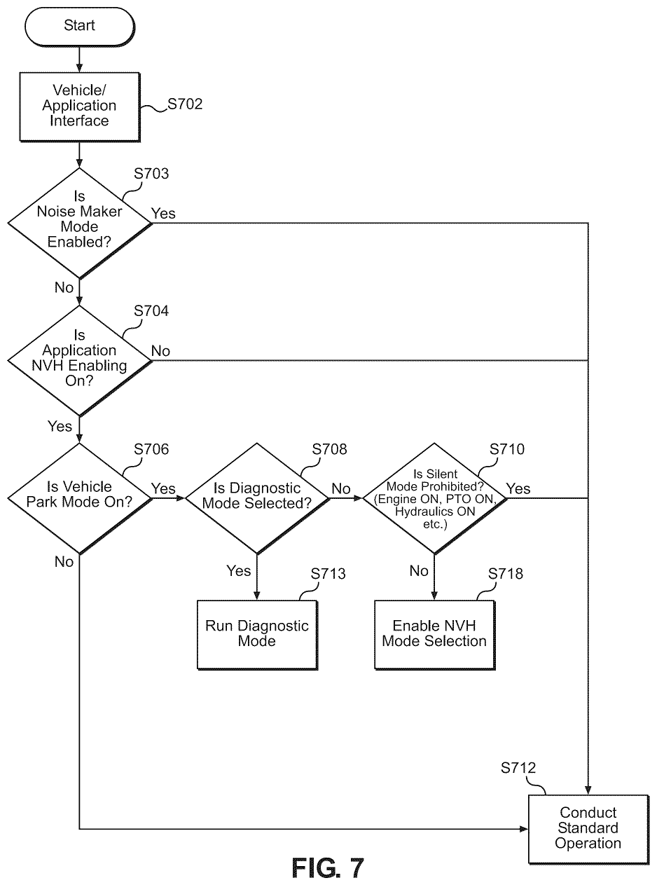

FIG. 7 illustrates a method of operation according to one or more example embodiments. The flow chart shown in FIG. 7 may be implemented by the electronic data processing system shown in FIG. 2.

At S702, a user may input an NVH selection through an interface (e.g., interface 208).

At S703, the electronic data processing system (e.g., the processor 264 executing instructions stored in the storage device 260) determines if a noise maker mode is enabled. If the noise maker mode is enabled, the electronic data processing system controls the electric drive system to determine operate in a standard operation at S712. In the standard operation, the default switching table is used for the switching frequencies.

If the noise maker mode is not enabled, at S704, the electronic data processing system (e.g., the processor 264 executing instructions stored in the storage device 260) determines if the NVH is enabled such that NVH modes (e.g., the modes shown in FIG. 3) are selectable. If NVH is not enabled, the electronic data processing system controls the electric drive system to operate in the standard operation at S712.

If NVH is enabled, the electronic data processing system determines if a vehicle park mode is on at S706. In the vehicle park mode, the controller determines whether the vehicle is parked. If the vehicle park mode is not on, the electronic data processing system controls the drive system to operate in a standard operation at S712. If the vehicle park mode is on, the electronic data processing system determines if the diagnostic mode is selected at S708. If the diagnostic mode is selected, the electronic data processing system performs the diagnostic mode (e.g., as shown in FIG. 6) at S713.

If the diagnostic mode is not selected, the electronic data processing system determines whether a silent mode is prohibited at S710. Silent mode may be prohibited if hydraulics are on, if an engine is on and/or if power take-off (PTO) is on, for example. If the silent mode is prohibited, the electronic data processing system controls the electric drive system to operate in the standard operation at S712.

If the silent mode is not prohibited, the electronic data processing system enables NVH mode selection at S718.

As described above, at least some example embodiments provide an inverter system that reduces (or removes) resonance based on the inputs of the electric machine without additional hardware costs.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. An electric drive system comprising:
an inverter configured to convert a direct current (DC) voltage into an alternating current (AC) voltage for an electric machine; and
processing circuitry configured to cause the electric drive system to,
obtain parameters of the electric machine,
obtain a mode of operation for the electric machine, the mode of operation related to at least one of noise, vibration or harshness, and
control the electric machine based on the parameters of the electric machine and the obtained mode of operation.

2. The electric drive system of claim 1, further comprising:
a memory storing a first set of switching frequencies for the inverter, wherein the processing circuitry is configured to generate a second set of switching frequencies for the inverter based on the parameters of the electric machine.

3. The electric drive system of claim 2, wherein the second set of switching frequency values for the inverter reduces resonance of the electric drive system relative to the first set of switching frequency values.

4. The electric drive system of claim 2, wherein the processing circuitry is configured to,
determine at least one resonance frequency based on the parameters of the electric machine,
determine if a harmonic frequency of the electric drive system is the at least one resonance frequency or is within a first threshold of the at least one resonance frequency, and
adjust a particular switching frequency of the first set of switching frequencies based on whether the harmonic frequency is the at least one resonance frequency or is within the first threshold of the at least one resonance frequency.

5. The electric drive system of claim 4, wherein the processing circuitry is configured to adjust the particular switching frequency by applying an adjustment value to the particular switching frequency and determining if the adjusted frequency is between a minimum switching frequency and a maximum frequency.

6. The electric drive system of claim 4, wherein the parameters include at least one of an inner diameter of a stator of the electric machine, an outer diameter of a stator of the electric machine, a stack length of the electric machine, a Poisson's ratio of the electric machine, a mass density of the electric machine, a packing factor of the electric machine or a modulus of elasticity of the electric machine.

7. The electric drive system of claim 4, wherein the processing circuitry is configured to determine the at least one resonance frequency using at least one of Hoppe's equation or Yang's equation.

8. The electric drive system of claim 4, wherein the processing circuitry is further configured to,
adjust the particular switching frequency by shifting the particular switching frequency by a predetermined amount.

9. The electric drive system of claim 2, wherein the processing circuitry configured to cause the electric drive system to select one of the second set of switching frequency values based on a speed of the electric machine, the selected one of the second set of switching frequency values being a switching frequency command associated with the speed of the electric machine.

10. The electric drive system of claim 1, wherein the processing circuitry is configured to cause the electric drive system to obtain the mode of operation from a user of the electric drive system.

11. The electric drive system of claim 1, wherein the electric drive system is a battery electric power drive system or a hybrid electric power drive system.

12. A vehicle comprising:
the electric drive system of claim 1.

13. A method of controlling an electric drive system, the method comprising:
obtaining parameters of an electric machine of the electric drive system;
obtaining a mode of operation for the electric machine, the mode of operation related to at least one of noise, vibration or harshness; and
controlling the electric machine based on the parameters of the electric machine and the obtained mode of operation.

14. The method of claim 13, further comprising:
storing a first set of switching frequencies for an inverter of the electric drive system; and
generating a second set of switching frequency values for the inverter based on the parameters of the electric machine.

15. The method of claim 14, wherein the second set of switching frequency values for the inverter reduces resonance of the electric drive system relative to the first set of switching values.

16. The method of claim 14, further comprising:
determining at least one resonance frequency based on the parameters of the electric machine;
determining if a harmonic frequency of the electric drive system is the at least one resonance frequency or is within a first threshold of the at least one resonance frequency; and
adjusting a particular switching frequency of the first set of switching frequencies based on whether the harmonic frequency is the at least one resonance frequency or is within the first threshold of the at least one resonance frequency.

17. The method of claim 16, wherein the adjusting adjusts the particular switching frequency by applying an adjustment value to the particular switching frequency and determining if the adjusted frequency is between a minimum switching frequency and a maximum frequency.

18. The method of claim 16, wherein the parameters include at least one of an inner diameter of a stator of the electric machine, an outer diameter of a stator of the electric machine, a stack length of the electric machine, a Poisson's ratio of the electric machine, a mass density of the electric machine, a packing factor of the electric machine or a modulus of elasticity of the electric machine.

19. The method of claim 16, wherein the adjusting adjusts the particular switching frequency by shifting the particular switching frequency by a predetermined amount.

20. The method of claim 14, wherein further comprising:
selecting one of the second set of switching frequency values based on a speed of the electric machine, the selected one of the second set of switching frequency values being a switching frequency command associated with the speed for the electric machine.
